(19) United States
(12) Patent Application Publication
(10) Pub. No.: US 2010/0149631 A1
(43) Pub. Date: Jun. 17, 2010

(54) CHARGED PARTICLE USED FOR ELECTROPHORETIC DISPLAY MEDIUM, ELECTROPHORETIC DISPLAY MEDIUM COMPRISING THE CHARGED PARTICLE, AND IMAGE DISPLAY DEVICE USING THE ELECTROPHORETIC DISPLAY MEDIUM

(75) Inventor: Yumiko Oshika, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/712,426

(22) Filed: Feb. 25, 2010

Related U.S. Application Data
(63) Continuation-in-part of application No. PCT/JP2008/059764, filed on May 28, 2008.

(30) Foreign Application Priority Data
Sep. 5, 2007 (JP) 2007-230026

(51) Int. Cl. G02F 1/167; B32B 5/16

(52) U.S. Cl. 359/296; 428/403

(57) ABSTRACT

A charged particle to be used for an electrophoretic display medium in which a first attached material being charged with a predetermined polarity and a second attached material having a smaller adhesion force than that of the first attached material are attached to a mother particle, wherein the first attached material is a minute particle (hereinafter referred to as “first minute particle”), and the outermost surface of the second attached material is located outward relative to the outermost surface of the first minute particle in the radial direction of the mother particle, is provided.

### TECHNICAL FIELD

The present invention relates to a positively or negatively charged particle used for an electrophoretic display medium, an electrophoretic display medium comprising the charged particle, and an image display device using the electrophoretic display medium.

### BACKGROUND ART

Electrophoretic image display devices have recently been used in various fields including use as electronic paper. As an example of such electrophoretic image display devices, there can be exemplified an image display device in which a display medium comprising black-colored and white-colored charged particles is enclosed in a sealed space formed between a substrate on the display side where a common electrode is disposed and a substrate on the rear side where pixel electrodes are disposed. In this image display device, a black-colored charged particle and a white-colored charged particle are charged opposite, negative or positive, to each other, so that by changing the potential difference between the common electrode and pixel electrodes to make the black-colored and white-colored charged particles move, it is possible to change gradation for each pixel, and thus it is possible to display and rewrite a desired image.

In such charged particles contained in a display medium to be used for an electrophoretic image display device, it is necessary that the charged particles have a clear polarity and a sufficient charge potential to achieve excellent image displaying. To achieve this, it is proposed, for example, to use charged particles each comprising a mother particle to which oxide inorganic minute particles such as silicon oxide (silica) are attached

In a conventional charged particle, although a certain amount of charge is kept in a charged particle by oxide inorganic minute particles such as silicon oxide (silica) attached to a mother particle, such oxide inorganic minute particles have a property of being likely to be negatively charged. Therefore, when the charged particle is used as a positively charged particle, the particle as a whole tends to be negatively charged due to the oxide inorganic minute particles attached thereto.

Accordingly, when a display medium comprising a negatively charged particle and a positively charged particle to which an oxide inorganic minute particle is attached is used, there arises a problem that it is difficult to achieve excellent image displaying, compared with a display medium comprising an appropriately positively charged particle and a negatively charged particle.

Furthermore, while it is possible to consider attaching as a minute particle that tend to be positively charged, for example, a resin minute particle, to deal with the aforementioned problem, such a resin minute particle have a large adhesion force, and thus when the charged particle comes into contact with a substrate or the like, due to the adhesion force of the attached resin minute particle, there arises a problem that the charged particle adheres to the substrate or the like, which results in lowering the contrast of the displayed image.

### DISCLOSURE OF THE INVENTION

Therefore, an object of the present invention is to solve the aforementioned problems, and to provide a charged particle having a polarity and charge potential that allow an excellent image displaying, and capable of preventing its adhesion with a substrate or the like, and thereby displaying an excellent image with a high contrast, a display medium comprising the charged particle, and an image display device using the display medium.

In order, to solve the aforementioned problems, one embodiment of a charged particle to be used for an electrophoretic display medium according to the present invention is a charged particle in which a first attached material being charged with a predetermined polarity and a second attached material having a smaller adhesion force than that of the first attached material are attached to a mother particle, wherein the first attached material is a minute particle (hereinafter referred to as “first minute particle”), and the outermost surface of the attached second material is located outward relative to the outermost surface of the first minute particle in the radial direction of the mother particle.

Another embodiment of the charged particle to be used for an electrophoretic display medium according to the present invention is a charged particle in which a first attached material being charged with a predetermined polarity and a second attached material having a smaller adhesion force than that of the first attached material are attached to a mother particle, wherein the first attached material is a minute particle (hereinafter referred to as “first minute particle”), and when an end portion that is most distant from the center of the charged particle is called an outer end portion, the distance from the center of the charged particle to the outer end portion of the second attached material is longer than the distance from the center of the charged particle to the outer end portion of the first minute particle.

### BRIEF DESCRIPTION OF THE DRAWINGS

FIG. 1 is sectional side view schematically showing an overall structure of one embodiment of an image display device in which a display medium comprising charged particles according to the present invention is enclosed.

FIG. 2 is a view schematically showing positively charged particles and negatively charged particles according to the present invention.

FIG. 3 is a sectional side view schematically showing a state where the particle size of a second minute particle is smaller than the particle size of a first minute particle, and the second minute particle is in contact with a flat surface.

### DETAILED DESCRIPTION OF THE INVENTION

### Overall Explanation

A first embodiment of a charged particle to be used for an electrophoretic display medium according to the present invention is a charged particle in which a first attached material being charged with a predetermined polarity and a second attached material having a smaller adhesion force than that of the first attached material are attached to a mother particle, wherein the first attached material is a minute particle (hereinafter referred to as “first minute particle”), and the outermost surface of the second attached material is located outward relative to the outermost surface of the first minute particle in the radial direction of the mother particle.

Here, the first attached material comprises a minute particle, and is called a first minute particle. On the other hand, as a second attached material, it is possible to use, as described later, a minute particle, a material in the form of a layer that is formed by coating or the like, or a material in any other forms or manners.

As a manner to attach a first minute particle and a second attached material to a mother particle, the case where both a first minute particle and a second attached material are adhered to the surface of a mother particle, as well as the case where a first minute particle is adhered to the surface of a mother particle, and a second attached material is further adhered thereto, are included.

The polarity of a charged first minute particle can be positive or negative. Furthermore, a mother particle can be a charged particle or an uncharged particle, and in the case of a charged particle, it desirably has the same charged polarity as that of a first minute particle.

A second attached material may be a charged minute particle or an uncharged minute particle, and in the case of a charged minute particle, the charged polarity can be positive or negative. However, when a second attached material has a polarity different from that of a first minute particle, it preferably has a small charge potential.

The polarity of a charged particle as a whole is determined by the charged polarity of the first minute particle, despite of the charged polarity of the mother material and the second minute particle, and the charged polarity of a charged particle can be positive or negative depending on the polarity of the first minute particle. While the charge potential of a charged particle as a whole is determined by the combination of the charge potentials of the mother material, the first minute particle, and the second attached material, it is strongly affected by the charge potential of, in particular, the first minute particle. Since the surface area to be charged by a first minute particle attached to a mother particle can be increased, it is possible to make the polarity of the charged particle clear, and enlarge the charge potential thereof.

The adhesion force of a second attached material is smaller than that of a first minute particle, and, for example, when the second attached material that is attached to a charged particle comes into contact with a substrate or the like, it desirably has an adhesion force low enough not to adhere to the substrate or the like.

In the present embodiment, the outermost surface of a second attached material is located outward relative to the outermost surface of a first minute particle in the radial direction of a mother particle, and thus even in the case where the adhesion force of the first minute particle is large, when the charged particle comes into contact with a substrate or the like, the second attached material mainly comes into contact with the substrate or the like, so that it is possible to effectively prevent the charged particle from adhering to the substrate or the like.

As stated above, since it is possible in the present embodiment to increase the surface area to be charged by attaching a charged first minute particle to a mother material, and a charged particle can accordingly have a clear polarity and a sufficient charge potential, it is possible to provide excellent image displaying. Furthermore, when a charged particle comes into contact with a substrate or the like, a second attached material having a smaller adhesion force than that of a first minute particle mainly comes into contact with a substrate or the like, so that it is possible to effectively prevent the charged particle from adhering to the substrate or the like, and to display an image with a high contrast. Therefore, it is possible in the present embodiment to obtain a charged particle to be used for an electrophoretic display medium capable of effectively displaying an image with a high contrast.

A second embodiment of the charged particle according to the present invention is a charged particle in which a first attached material being charged with a predetermined polarity and a second attached material having a smaller adhesion force than that of the first attached material are attached to a mother particle, wherein the first attached material is a minute particle (hereinafter referred to as “first minute particle”), and when an end portion that is most distant from the center of the charged particle is called an outer end portion, the distance from the center of the charged particle to the outer end portion of the second attached material is longer than the distance from the center of the charged particle to the outer end portion of the first minute particle.

In this embodiment, when the end portion that is most distant from the center of the charged particle is called an outer end portion, the distance from the center of the charged particle to the outer end portion of the second material attached is longer than the distance from the center of the charged particle to the outer end portion of the first minute particle. Therefore, when the charged particle comes into contact with a substrate or the like, the second attached material having a smaller adhesion force than that of the first minute particle mainly comes into contact with the substrate or the like, so that it is possible to effectively prevent the charged particle from adhering to the substrate or the like. Accordingly, as stated above, the charged particle can have a clear polarity and a sufficient charge potential by the first minute particle, and it is possible to effectively prevent the charged particle from adhering to the substrate or the like by the second attached material, so that it is possible to obtain a charged particle to be used for an electrophoretic display medium, capable of effectively displaying an image with a high contrast.

A third embodiment of the charged particle according to the present invention is the charged particle in which the second attached material is a minute particle (hereinafter referred to as “second minute particle”).

In this embodiment, the charged particle has a structure in which the first minute particle and the second minute particle are attached to the mother particle. Thus, since materials to be attached are both minute particles, it is possible to easily attach the first minute particle and the second minute particle in a desired ratio and arrangement.

A fourth embodiment of the charged particle according to the present invention is the charged particle in which the first minute particle is adhered to the surface of the mother particle, and the second minute particle is adhered thereto.

In this embodiment, since the second minute particle is adhered to the first minute particle, the second attached material having a smaller adhesion force than that of the first minute particle mainly comes into contact with a substrate or the like, so that it is possible to effectively prevent the charged particle from adhering to the substrate or the like.

A fifth embodiment of the charged particle according to the present invention is the charged particle in which, when the particle size of the first minute particle is d1 and the particle size of the second minute particle is d2, the minute particles are attached such that there is the relationship:

d2≧d1

In this embodiment, since it can ensure that the second attached material having a smaller adhesion force than that of the first minute particle contacts with a substrate or the like, it is possible to effectively prevent the charged particle from adhering to the substrate or the like.

A sixth embodiment of the charged particle according to the present invention is the charged particle in which the first minute particle is a positively charged resin minute particle, and the second minute particle is an oxide inorganic minute particle.

Here, while a resin minute particle is a typical minute particle that is likely to be positively charged, it also has the property of large adhesion force. While an oxide inorganic minute particle has a small adhesion force, it has the property of being likely to be negatively charged. Therefore, by attaching, in an appropriate ratio, a positively charged resin minute particle as first minute particle, and an oxide inorganic minute particles as second minute particle to the mother particle, the charged particle in this embodiment can have a sufficient positive charge potential by the positively charged resin minute particle, and at the same time, it is possible to achieve prevention of its adhesion to a substrate or the like by allowing the oxide inorganic minute particle to mainly come into contact with a substrate or the like.

A seventh embodiment of the charged particle according to the present invention is a charged particle in which the coverage with the second minute particle is 25 to 50%.

By causing the coverage with the second minute particle to be in the range of 25 to 50%, like this embodiment, it is possible to prevent adhesion between a charged particle and a substrate or the like by the second minute particle, and, at the same time, to suppress the influence of the second minute particle on the charge potential to a certain level, and thus a charged particle can have a sufficient charge potential, and prevent its adhesion to a substrate or the like.

An eighth embodiment of the charged particle according to the present invention is a charged particle in which the charge potential of the charged particle in a state where the first minute particle has been adhered to the surface of the mother material, and the second minute particle has not been adhered, is 110 mV or more.

By causing the charge potential of the charged particle in a state where the second minute particle has not been adhered to be 110 mV or more, like this embodiment, it is possible to cause the charged particle to have a charged polarity and a charge potential that enable excellent image displaying even after the second minute particles are attached thereto.

A first embodiment of an electrophoretic display medium according to the present invention is a display medium comprising any of the aforementioned charged particles.

By using an electrophoretic display medium according to this embodiment, it is possible to provide excellent image displaying with a high contrast.

A second embodiment of the electrophoretic display medium according to the present invention is the display medium comprising the aforementioned positively charged particle and a negatively charged particle in which the oxide inorganic minute particle is attached to the mother material.

In this embodiment, since it is possible to obtain the electrophoretic display medium comprising the negatively charged particle and the positively charged particle having a clear polarity and a sufficient charge potential with no possibility of being adhered to a substrate or the like, so that it is possible to provide excellent image displaying with a high contrast using this electrophoretic display medium.

A first embodiment of an image display device according to the present invention is an image display device comprising the aforementioned electrophoretic display medium.

In the same manner as mentioned above, it is possible to provide excellent image displaying with a high contrast using an image display device of this embodiment.

Another embodiment of the charged particles to be used for an electrophoretic display medium according to the present invention is a charged particle in which a first minute particle charged with a predetermined polarity and a second minute particle having a smaller surface adhesion force than that of the first minute particle are attached, wherein when the charged particle comes into contact with another surface, the second minute particle contacts with the surface, and the mother particle and the first minute particle do not contact with the surface.

In this embodiment, when the charged particle comes into contact with another surface such as a substrate, the second minute particle contacts with the surface, so that adhesion between the charged particle and the substrate or the like can be effectively prevented. Therefore, in the same manner as mentioned above, it is possible to make the polarity clear and enlarge the charge potential by the first minute particle, and to prevent adhesion with a substrate or the like by the second attached material, so that it is possible to obtain a charged particle which provides excellent image displaying with a high contrast.

### EFFECT OF THE INVENTION

As described above, in the present invention, since it is possible to increase the surface area to be charged by attaching a charged first minute particle to a mother material, the charged particle can have a clear polarity and a sufficient charge potential, so that it is possible to provide excellent image displaying. Furthermore, when the charged particle comes into contact with a substrate or the like, a second attached material having a smaller adhesion force than that of the first minute particle mainly contacts with the substrate or the like, and thereby effectively preventing the charged particle from adhering to the substrate or the like, so that it is possible to display an excellent image with a high contrast. Therefore, according to the present invention, it is possible to obtain a charged particle to be used for an electrophoretic display medium capable of displaying an excellent image with a high contrast.

Moreover, in a display medium comprising the charged particle, and an image display device using the display medium, it is possible to achieve excellent image displaying with a high contrast as well.

### DESCRIPTION OF ILLUSTRATED EMBODIMENTS

A charged particle according to the present invention, a display medium comprising the charged particle, and an image display device using the display medium will be described in detail below referring to the drawings.

### (Description of One Embodiment of an Image Display Device According to the Present Invention)

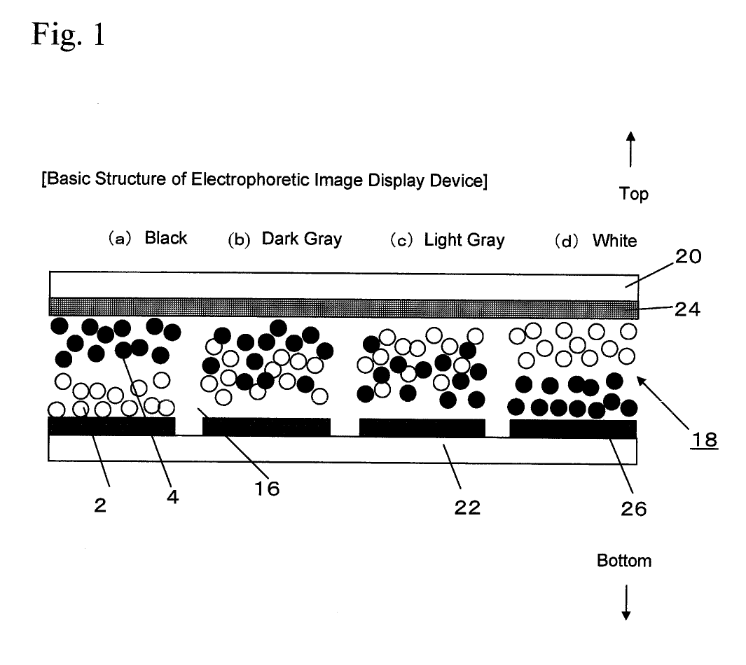

First, an embodiment of an image display device using a display medium comprising a charged particle according to the present invention will be described referring to FIG. 1. FIG. 1 is a sectional side view schematically showing an overall structure of an image display device 2, in which the upper side of the sheet corresponds to the display portion side of the image display device 2.

An image display device 18 comprises a transparent display substrate 20 disposed on the display portion side, a rear surface substrate 22 arranged approximately in parallel with the display substrate 20 with a predetermined distance therebetween. Furthermore, on the inner side (lower side of the sheet) of the display substrate 20, a common electrode 24 made of a transparent member is fixed, and on the inner side (upper side of the sheet) of the rear surface substrate 22, a plurality of pixel electrodes 26 each provided for each pixel are fixed.

In a sealed space formed between the display substrate 20 to which the common electrode 24 is fixed and the rear surface substrate 22 to which a plurality of pixel electrodes 26 are fixed, a display medium 16 comprising positively charged particles 2 and negatively charged particles 4 is enclosed. It should be noted that while black-colored particles are positively charged and white-colored particles are negatively charged as an example in this embodiment, it is not limited thereto.

The basic principle for displaying and rewriting an image in the electrophoretic image display device 18 having such a basic structure, will be explained. Here, FIG. 1 shows four display states (a) to (d) having different gradations for each pixel electrode 26. Namely, a state displaying an image of four gradations: (a) black-colored, (b) dark gray, (c) light gray, and (d) white-colored is shown. It should be noted that while FIG. 1 shows a plurality of pixel electrodes 26 arranged in one sealed space, an independent sealed space may be formed for each pixel electrode 26 using a partition or the like (not shown) for clear indication of gradation by each pixel electrode 26.

In FIG. 1, when a predetermined voltage is applied to a pixel electrode 26 to cause the rear surface substrate 22 to be positive and generate a sufficient electric field with the potential on the display substrate 20 side as reference potential, black-colored positively charged particles 2 are distributed in the vicinity of the display substrate 20, and white-colored negatively charged particles 4 are distributed in the vicinity of the rear surface substrate 22 as shown in FIG. 1(a). Since gradation is determined by the average distribution of black-colored charged particles 2 and white-colored charged particles 4 within the display portion, and thus black-color is displayed on the display substrate 20 in this case.

Furthermore, when a predetermined voltage is applied to a pixel electrode 26 to cause the rear surface substrate 22 to be negative and generate a sufficient electric field with the potential on the display substrate 20 side as reference potential, black-colored positively charged particles 2 are distributed in the vicinity of the rear surface substrate 22, and white-colored negatively charged particles 4 are distributed in the vicinity of the display substrate 20 as shown in FIG. 1(d), and thus white color is displayed on the display substrate 20.

Moreover, when black-colored charged particles 2 and white-colored charged particles 4 are caused to be distributed in the vicinity of an intermediate position between the display substrate 20 and the rear surface substrate 22 by controlling the magnitude of the voltage to be applied to the pixel electrode 26 and the voltage application time with the potential on the display substrate 20 side as reference potential, both black-colored charged particles 2 and white-colored charged particles 4 can be recognized from the display substrate 20 side, so that the gradation becomes gray. In this case, by changing the degree of distribution of charged particles, it is possible to display dark gray as shown in FIG. 1(b) or light gray as shown in FIG. 1(c).

While only two types of gray differing in density are shown in FIG. 1, densities are not limited to those, and gray with a desired density can be displayed by controlling the magnitude of the voltage to be applied to the pixel electrode 26 and the voltage application time.

Based on the principle mentioned above, by applying a predetermined voltage to the pixel electrode 26 to change the potential between the display substrate 20 side and rear surface substrate 22 side, it can cause charged particles 2, 4 to move, and thus it is possible to change the degradation for each pixel. That is, it is possible to rewrite a displayed image.

### (Overall Description of Charged Particles and Display Medium According to the Present Invention)

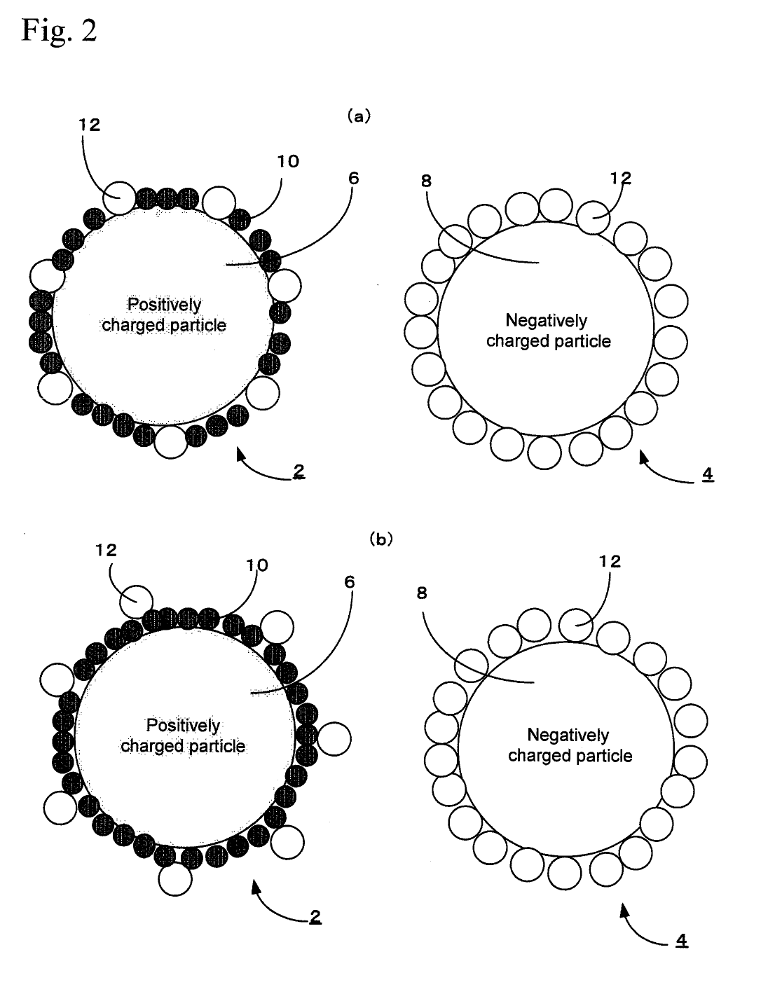

Next, by referring to FIG. 2, one embodiment of a charged particle according to the present invention, and a display medium comprising the charged particle will be described. Here, FIG. 2 shows positively charged particles and negatively charged particles, and FIGS. 2(a) and (b) both show positively charged particles 2 on the left side and negatively charged particles 4 on the right side. In FIG. 2, positively charged particles 2 are colored black and negatively charged particles 4 are colored white, as an example, but they are not limited thereto.

Furthermore, when FIGS. 2(a) and (b) are compared, while the structures of the positively charged particles on the left side are different between FIGS. 2(a) and (b), negatively charged particles 4 on the right side are identical between FIGS. 2(a) and (b).

<Description of Embodiment Shown in FIG. 2(a)>

First, the embodiment that is shown in FIG. 2(a) will be described. In the positively charged particle 2 on the left side of FIG. 2(a), positively charged resin minute particles 10 as first minute particle, and oxide inorganic minute particles 12 as second minute particle are adhered to the surface of a positively charged mother particle 6. Here, the positively charged resin minute particle 10 has the properties of being likely to be positively charged, and of strong adhesion force. On the other hand, the oxide inorganic minute particle 12 has the properties of being likely to be negatively charged, and of weak adhesion force. It should be noted that while in FIG. 2, positively charged resin minute particles 10 are colored to distinguish minute particles, which does not show the actual colors of particles and minute particles.

Here, while methacryl resin (PMMA) is used as a material for the mother particle 6 to be positively charged and positively charged resin minute particles 10 in this embodiment, the material is not limited to this, and in addition thereto, fluorinated acryl resin, polycarbonate (PC), high-density polyethylene (HDPE), polypropylene (PP), acrylonitrile butadiene styrene (ABS), polyethylene terephthalate (PET), polyacetal (POM), polystyrene (PS) or the like can be used, and furthermore, it is possible to chemically modify the resin surface with a polarity functional group such as carboxyl group.

Furthermore, while silicon oxide (silica) is used as a material for the oxide inorganic minute particle 12 in this embodiment, the material is not limited to this, and in addition thereto, titanium oxide, alumina, iron oxide or the like can be used.

Here, since positively charged resin minute particles 10 are adhered to the surface of the positively charged mother particle 6, it is possible to enlarge the surface area to be charged, and thereby further strengthening the potential of the positively charged mother particle 6. Moreover, although the oxide inorganic minute particle 12 has the property of being likely to be negatively charged, by appropriately suppressing the ratio of the oxide inorganic minute particle 12 adhered compared with positively charged resin minute particles 10 adhered, the charged particle 2 as a whole can have a clear polarity and a sufficient charge potential that enable excellent image displaying. As for the ratio between positively charged resin minute particles 10 adhered and oxide inorganic minute particles 12 adhered will be described in detail later.

Furthermore, as is clear from FIG. 2(a), the outermost surface of the oxide inorganic minute particle 12 is located outward relative to the outermost surface of the positively charged resin minute particle 10 in the radial direction of the mother particle 6. In other words, when an end portion that is most distant from the center of the charged particle 2 is called an outer end portion, the distance from the center of the charged particle 2 to the outer end portion of the oxide inorganic minute particle 12 is longer than the distance from the center of the charged particle 2 to the outer end portion of the positively charged resin minute particle 10.

Therefore, when the charged particle 2 comes into contact with a substrate or the like, the oxide inorganic minute particle 12 having a weak adhesion force mainly contacts with the substrate or the like, and thus it is possible to effectively prevent the charged particle 2 from adhering to the substrate or the like.

Furthermore, in the negatively charged particle 4 shown on the right side in FIG. 2(a), oxide inorganic minute particles 12 are adhered to the surface of the negatively charged mother particle 8. Here, since the oxide inorganic minute particles 12 having, as stated above, the property of being likely to be negatively charged are adhered to the surface of the negatively charged mother particle 8, it is possible to enlarge the surface area to be charged, and thereby further strengthening the potential of the negatively charged mother particle 8.

In addition, when the charged particle 4 comes into contact with a substrate or the like, the oxide inorganic minute particle 12 having a weak adhesion force mainly contacts with the substrate or the like, and thus it is possible to effectively prevent the charged particle 4 from adhering to the substrate or the like.

As stated above, by displaying an image with an image display device 18 as shown in FIG. 1, using a display medium 16 comprising the positively charged particle 2 and the negatively charged particle 4 as shown in FIG. 2(a), it is possible to achieve excellent image displaying with a high contrast.

<Description of Embodiment Shown in FIG. 2(b)>

Next, the embodiment shown in FIG. 2(b) will be described. Here, since the negatively charged particle 4 on the right side of FIG. 2(b) is identical with the one in FIG. 2(a), only the positively charged particle 2 on the left figure of FIG. 2(b) will be described.

In the positively charged particle 2 on the left side of FIG. 2(b), positively charged resin minute particles 10 are adhered to the surface of a positively charged mother particle 6, and oxide inorganic minute particles 12 are further adhered thereto. Therefore, as is clear from FIG. 2(b), the outermost surface of the oxide inorganic minute particle 12 is located outward relative to the outermost surface of the positively charged resin minute particle 10 in the radial direction of the mother particle 6; in other words, when an end portion that is most distant from the center of the charged particle 2 is called an outer end portion, the distance from the center of the charged particle 2 to the outer end portion of the oxide inorganic minute particle 12 is longer than the distance from the center of the charged particle 2 to the outer end portion of the positively charged resin minute particles 10.

Therefore, when a charged particle 2 comes into contact with a substrate or the like, the oxide inorganic minute particle 12 having a weak adhesion force mainly contacts with the substrate or the like, and thus it is possible to effectively prevent the charged particle 2 from adhering to the substrate or the like.

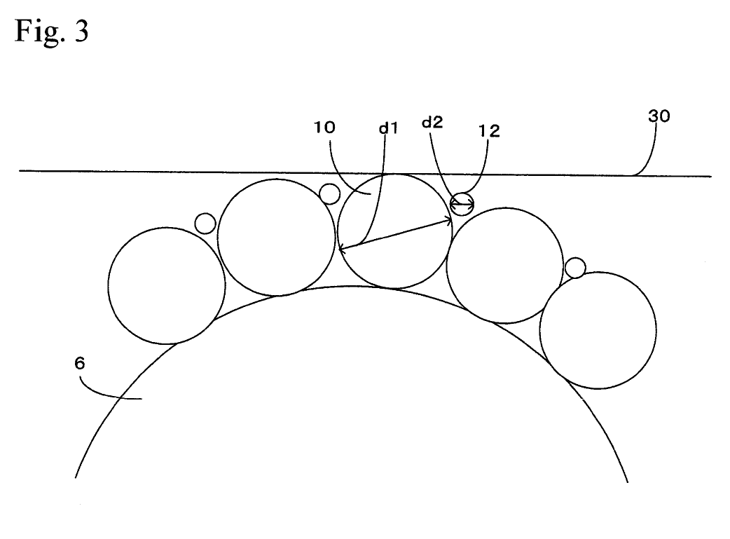

In the case as shown on the left side of FIG. 2(b), if the particle size d2 of the oxide inorganic minute particle 12 is smaller than the particle size d1 of the positively charged resin minute particle 10, there can be considered a case where, as shown in FIG. 3, the positively charged resin minute particle 10 contacts with a flat surface 30 of a substrate or the like. In this case, as long as the particle size d2 of the oxide inorganic minute particle 12 as second minute particle is not smaller than that of the particle size d1 of the positively charged resin minute particles 10 as first minute particle, there is no possibility of such state as shown in FIG. 3 being occurred, and when the charged particle 2 comes into contact with a substrate or the like, the oxide inorganic minute particle 12 having a weak adhesion force mainly contacts with the substrate or the like, and thus it is considered possible to effectively prevent the charged particle 2 from adhering to the substrate or the like.

Furthermore, concerning the charge potential of the charged particle 2, as stated above, since the positively charged resin minute particles 10 are adhered to the surface of the positively charged mother particle 6, it is possible to enlarge the surface area to be charged, and thereby further strengthening the potential of the positively charged mother particle 6. Furthermore, by appropriately suppressing the ratio of the oxide inorganic minute particles 12 adhered compared with the positively charged resin minute particles 10, the charged particle 2 as a whole can have a clear polarity and a sufficient charge potential that allows excellent image displaying.

As discussed above, by displaying an image with an image display device 18 as shown in FIG. 1, using a display medium 16 comprising the positively charged particle 2 and the negatively charged particle 4 as shown in FIG. 2(b), it is possible to achieve excellent image displaying with a high contrast.

### EXAMPLE

Next, examples of actually preparing a charged particle according to the present invention and a display medium comprising the charged particle, and performing a given test, will be described in detail below.

### Example 1

### Description of Example Concerning Adhesion Force and Charged Polarity

First, samples of four types of charged particles: (1) Charged Particle 1, composed only of a mother particle; (2) Charged Particle 2, in which only a positively charged resin minute particle (first minute particle) is attached to a mother particle; (3) Charged Particle 3, in which only an oxide inorganic minute particle (second minute particle) is attached to a mother particle; and (4) Charged Particles 4, in which a resin minute particle (first minute particle) and an oxide inorganic minute particle (second minute particle) are attached to a mother particle, were prepared, and the adhesion forces and charged polarities of the prepared Charged Particles 1-4 were measured.

The detailed compositions of Charged Particles 1-4 are as follows: (1) Charged Particle 1, composed only of a mother particle made of carbon black-containing methacryl resin (PMMA); (2) Charged Particle 2, in which only an acryl resin minute particle as positively charged resin minute particle is attached to a mother particle made of carbon black-containing methacryl resin (PMMA); (3) Charged Particle 3, in which only a minute particle of silicon oxide (silica) as oxide inorganic minute particle is attached to a mother particle made of carbon black-containing methacryl resin (PMMA); and (4) Charged Particle 4, in which an acryl resin minute particle as positively charged resin minute particle is attached to a mother particle made of carbon black-containing methacryl resin (PMMA), and silicon oxide (silica) as oxide inorganic minute particle is further attached thereon, were prepared, and then their adhesion forces and charged electrodes were measured. It should be noted that in this example, Charged Particles 1-4 are black-colored particles.

Furthermore, the method of attaching minute particles in preparing the aforementioned Charged Particles 2-4 comprises mixing a predetermined amount of mother particles and minute particles to be attached thereto, charging them into a hybridization system (manufactured by Nara Machinery Co., Ltd.), and rotating the rotor at a high speed for a predetermined time to obtain charged particles with minute particles attached thereto. Here, the method for preparing Charged Particle 4 that corresponds to a charged minute particle according to the present invention will be described in detail below.

10 g of methacryl resin (PMMA) particles and 0.4 g of acryl resin minute particles were mixed, and charged into the hybridization system. The mixture was then treated under the conditions of rotation speed of the rotor of the hybridization system: 9700 rpm and treating time: 3 minutes to obtain positively charged particles on which positively charged resin minute particles are attached. Subsequently, 10 g of the prepared positively charged particles and 0.4 g of silicon oxide (silica) minute particles were treated under the conditions of rotation speed of the rotor of the hybridization system: 9700 rpm and treating time: 3 minutes to obtain charged particles in which positively charged resin minute particles and oxide inorganic minute particle were attached to mother particles.

Next, using an adhesion force measuring equipment, adhesion forces of the prepared Charged Particles 1-4 were measured. Specifically, measurement was performed using a centrifugal adhesion force analyzer (manufactured by Nano Seeds Corporation) as an adhesion force measuring equipment. First, Charged Particles 1-4 were sprayed on glass substrates equipped with ITO, and the glass substrates were placed on the centrifugal machine of the centrifugal adhesion force analyzer. Furthermore, after rotating it at a predetermined rotation speed, the remaining surface areas of the charged particles were obtained using a microscope and an image analyzer, and their respective average adhesion forces (unit nN) when the remaining rate is 50% were obtained using respective remaining rates and the centrifugal force applied to the charged particles.

Furthermore, as to the charged polarity of the charged particles, the charged polarity of Charged Particles 1-4 were measured using a zeta potential analyzer (manufactured by Microtec Co., Ltd.), and results as shown in Table 1 below were obtained.

As stated previously, methacryl resin (PMMA) minute particles used as mother particle and acryl resin minute particles to be attached thereto have the property of being likely to be positively charged, and silicon oxide (silica) minute particles to be further attached thereto have the property of being likely to be negatively charged.

TABLE 1

| Sample | Adhesion force [nN] | Charged Polarity |
|---|---|---|
| Charged Particle 1 | 100 | Positive |
| Charged Particle 2 | 70 | Positive |
| Charged Particle 3 | 30 | Negative |
| Charged Particle 4 | 30 | Positive |

As is clear from Table 1, the adhesion forces of Charged Particle 3 and Charged Particle 4 in which an oxide inorganic minute particle (silicon oxide (silica) minute particle) having a weak adhesion force is attached to a mother material are suppressed to a lower level, compared with Charged Particle 1 and Charged Particle 2 composed only of a positively charged resin material (methacryl resin (PMMA) particle or acryl resin minute particle) having a large adhesion force. Therefore, it has been demonstrated that by attaching an oxide inorganic minute particle on a mother material, it is possible to reduce the adhesion force of a charged particle.

Furthermore, concerning charge polarity, Charged Particle 1, composed only of a positively charged mother particle; Charged Particles 2, in which only a positively charged resin minute particle (acryl resin minute particles) is attached to a positively charged mother particle; and Charged Particle 4, in which a positively charged resin minute particle (acryl resin minute particle) and a negatively charged oxide inorganic minute particle (silicon oxide (silica) minute particle) are attached to a positively charged mother particle, were positively charged. On the other hand, Charged Particle 3, in which only a negatively charged oxide inorganic minute particle (silicon oxide (silica) minute particle) is attached to a positively charged mother particle, was negatively charged.

That is, regarding Charged Particle 3, the charged particle as a whole was negatively charged by the influence of the negatively charged oxide inorganic minute particle attached to the positively charged mother particle. On the other hand, regarding Charged Particle 4, by appropriately setting the ratio of minute particles attached (specific ratio thereof will be described later), it has been demonstrated to be possible to allow the charged particle to be positively charged as a whole due to the positively charged resin minute particle attached to the positively charged mother particle, despite of the influence of the attached negatively charged oxide inorganic minute particle.

As stated above, regarding Charged Particle 4 in which a positively charged resin minute particle is attached to a positively charged mother particle, and an oxide inorganic minute particle is further attached thereto, it has been demonstrated to be possible to render the charged particle to be positively charged due to the positively charged resin minute particle, and reduce the adhesion force of the charged particle by the oxide inorganic minute particle by appropriately setting the ratio of the minute particles attached.

### Example 2

### Description of Example Concerning Contrast

Next, a display medium was prepared by dispersing Charged Particles 1-4 (black-colored particles) prepared in the manner as described above and negatively charged particles (white-colored particles) in which silicon oxide (silica) is attached to a titanium oxide-containing methacryl resin (PMMA) particle, in a hydrocarbon-base solvent to which a small amount of alcohol is added. This display medium was enclosed between glass substrates with ITO disposed at a distance 25 μm apart from each other, and the brightness of the display surface was measured by a brightness measuring equipment (manufactured by TOPCON TECHNOHOUSE CORPORATION) to obtain contrast. Here, the contrast can be obtained from the ratio of the brightness at displaying white with respect to the brightness at displaying black, that is, the brightness of white display/the brightness of black display. The results of measurement are shown in Table 2.

TABLE 2

| Sample | Contrast |
|---|---|
| Charged Particle 1 | 4 |
| Charged Particle 2 | 4 |
| Charged Particle 3 | 6 |
| Charged Particle 4 | 8 |

As is clear from Table 2, it has been demonstrated that when a display medium comprising Charged Particle 3 or Charged Particle 4 having a weak adhesion force by the influence of an oxide inorganic minute particle, is used, the contrast of the display image was high. In particular, it has been demonstrated that when a display medium comprising Charged Particle 4 (i.e., a charged particle according to the present invention) that is definitely positively charged by the influence of the positively charged resin minute particle is used, image display with the highest contrast is possible.

### Example 3

### Description of Example Concerning Particle Size of Attached Minute Particles

Next, charged particles were prepared with differing in particle size ratio of a positively charged resin minute particle (first minute particle) relative to an oxide inorganic minute particle (second minute particle) attached to a positively charged mother particle, and the adhesion forces and contrasts were measured to examine the influence of particle size of minute particles attached.

Specifically, charged particles were prepared by using a positively charged methacryl resin (PMMA) particle as mother particle, adding thereto a positively charged acryl resin minute particle as positively charged resin minute particle, and further adding thereto a negatively charged silicon oxide (silica) minute particle as oxide inorganic minute particle. In this case, particle size ratio of an acryl resin minute particle relative to a silicon oxide (silica) minute particle varies from 0.4, 1.0, 1.3, to 2.0, and their adhesion forces and contrasts were measured. Here, the measurement methods of adhesion force and contrast are the same as the aforementioned measurement method. The results of measurement are shown in Table 3.

TABLE 3

| Particle size of oxide inorganic | | |
|---|---|---|
| minute particle/Particle | | |
| size of positively charged | Adhesion force | |
| resin minute particle | [nN] | Contrast |
| 0.4 | 70 | 4 |
| 1.0 | 50 | 8 |
| 1.3 | 30 | 8 |
| 2.0 | 30 | 8 |

As is clear from Table 3, it was clarified by this test that when the particle size of an oxide inorganic minute particle (silicon oxide (silica) minute particle) is smaller than the particle size of a positively charged resin minute particle (acryl resin minute particle), it is not possible to provide image display with a high contrast. On the other hand, when the particle size of an oxide inorganic minute particle (silicon oxide (silica) minute particle) is equal to or larger than the particle size of a positively charged resin minute particle (acryl resin minute particle), it is possible to achieve image display with a high contrast.

Namely, when the particle size of a first minute particle is d1, and when the particle size of a second minute particle is d2, it has been demonstrated that it is possible to display an image with a high contrast if d2≧d1.

### Example 4

### Description of Example Concerning Coverage with Oxide Inorganic Minute Particle

Next, charged particles were prepared with differing in coverage with an oxide inorganic minute particle (second minute particles) attached to a positively charged mother particle, and the adhesion forces and contrasts were measured to examine the influence of the coverage with an oxide inorganic minute particle.

Specifically, charged particles were prepared using a positively charged methacryl resin (PMMA) particle as mother particle, and attaching thereto an acryl resin minute particle as positively charged resin minute particle, and further attaching thereto a negatively charged silicon oxide (silica) minute particle as oxide inorganic minute particle. In this case, coverage with a silicon oxide (silica) minute particle attached varies from 0%, 9%, 25%, 38%, 50%, to 84%, and their adhesion forces and contrasts were measured. Here, the measurement methods of adhesion force, charged polarity and contrast are the same as the aforementioned measurement method. The results of measurement are shown in Table 4.

TABLE 4

| Coverage with inorganic | Adhesion force | Charged | |
|---|---|---|---|
| particle [%] | [nN] | polarity | Contrast |
| 0 | 100 | Positive | 4 |
| 9 | 60 | Positive | 4 |
| 25 | 40 | Positive | 8 |
| 38 | 30 | Positive | 8 |
| 50 | 30 | Positive | 8 |
| 84 | 30 | Negative | 6 |

As is clear from Table 4, when the coverage with an oxide inorganic minute particle is less than 25%, it was not possible to display an image with a high contrast. Reason of the above will be considered that: when such charged particle comes into contact with a substrate or the like, the area where positively charged resin minute particles are present on the outermost layer (i.e., the charged resin particles are exposed to the outside) contacts with the substrate or the like, and the charged particle adheres to the substrate or the like, and it was accordingly not possible to display an image with a high contrast.

Furthermore, when the coverage with an oxide inorganic minute particle is 50% or more, the proportion of the charged oxide inorganic minute particle relative to the charged particle as a whole is large, so that charged polarity of the charged particle as a whole shows negative.

On the other hand, it has been demonstrated that when the coverage with an oxide inorganic minute particle is within the range of 25% to 50%, it is possible to obtain a charged particle which has a small adhesion force and whose charged polarity definitely shows positive, and thus it is possible to display an image with a high contrast.

### Example 5

### Description of Example Concerning Charge Potential when Only Positively Charged Resin Minute Particles were Attached

Next, charged particles were prepared with changing the charge potential when only a positively charged resin minute particle (first minute particle) was attached on a mother particle, and then charged polarities of the charged particles to which an oxide inorganic minute particle (second minute particle) was further attached were measured, and the influence of the charge potential of charged particles where only a positively charged resin minute particle was attached was examined.

Specifically, when charged particles were prepared with using a positively charged methacryl resin (PMMA) particle as mother particle, and attaching thereto an acryl resin minute particle as positively charged resin minute particle, they were prepared with differing in charge potential from −20 mV (i.e., negatively charged), 75 mV, 110 mV, and 150 mV. Further, charged particles were prepared by attaching thereto a negatively charged silicon oxide (silica) minute particle as oxide inorganic minute particle with coverage of 50%, and the charged polarities were measured using the aforementioned zeta potential analyzer.

The results of measurement are shown in Table 5 below. It should be noted that “Weak”, “Middle”, and “Strong” in the column of “Charge of oxide inorganic minute particle” in Table 5 indicates as follows. That is, “Strong” refers to oxide inorganic minute particles which showed the largest charge potential (absolute value), “Weak” refers to oxide inorganic minute particles which showed the smallest charge potential (absolute value), and “Middle” refers to those inbetween when the charge potentials of the charged particles in which an oxide inorganic minute particle was attached with coverage of 100% on a mother particle charged with 110 mV were measured.

TABLE 5

| Charge potential | | |
|---|---|---|
| of charged | | Charged polarity |
| particle when | | of charged |
| only a positively | | particle when |
| charged resin | Charge of oxide | oxide inorganic |
| minute particle | inorganic minute | minute particle was |
| was attached [mV] | particle | also attached |
| −20 | Weak | Negative |
| | Middle | Negative |
| | Strong | Negative |
| 75 | Weak | Positive |
| | Middle | Positive |
| | Strong | Negative |
| 110 | Weak | Positive |
| | Middle | Positive |
| | Strong | Positive |
| 150 | Weak | Positive |
| | Middle | Positive |
| | Strong | Positive |

As is clear from Table 5, it has been clarified that when the charge potential of a charged particle in which only a positively charged resin minute particle is attached to a mother particle is lower than 110 mV, the charged polarity of the charged particle does not definitely show positive by the influence of a negatively charged oxide inorganic minute particle further attached thereto. On the other hand, when a charged particle in a state where only a positively charged resin minute particle has been attached to a mother particle has a charge potential of 110 mV or higher, the charged particle definitely shows positive as charged polarity when an oxide inorganic minute particle is further attached thereto with coverage of 50%.

It should be noted that the reason why 50% is employed as coverage with an oxide inorganic minute particle in this test is, as demonstrated in Example 4 above, that the range of appropriate coverage with an oxide inorganic minute particle is 25 to 50%, and the maximum coverage in that appropriate range (i.e., the coverage where a charged particle is most likely to be negatively charged) was employed.

### Description of Other Embodiments According to the Present Invention

The embodiments of a charged particle, a display medium comprising the charged particle, and an image display device using the display medium according to the present invention are not limited to those mentioned above, and other various embodiments are included in the present invention.

### EXPLANATION OF SYMBOLS

2 positively charged particle
4 negatively charged particle
6 positively charged mother particle
8 negatively charged mother particle
10 first minute particle
12 second minute particle
16 display medium
18 image display device
20 display substrate
22 rear surface substrate
24 common electrode
26 pixel electrode
30 flat surface

1. A charged particle used for an electrophoretic display medium in which a first attached material being charged with a predetermined polarity and a second attached material having a smaller adhesion force than that of the first attached material are attached to a mother particle, wherein the first attached material is a minute particle (hereinafter referred to as “first minute particle”), and the outermost surface of the second attached material is located outward relative to the outermost surface of the first minute particle in the radial direction of the mother particle.

2. A charged particle used for an electrophoretic display medium in which a first attached material being charged with a predetermined polarity and a second attached material having a smaller adhesion force than that of the first attached material are attached to a mother particle, wherein the first attached material is a minute particle (hereinafter referred to as “first minute particle”), and when an end portion that is most distant from the center of the charged particle is called an outer end portion, the distance from the center of the charged particle to the outer end portion of the second attached material is longer than the distance from the center of the charged particle to the outer end portion of the first minute particle.

3. The charged particle according to claim 1, wherein the second attached material is a minute particle (hereinafter referred to as “second minute particle”).

4. The charged particle according to claim 3, wherein the first minute particle is adhered to the surface of the mother particle, and the second minute particle is adhered thereto.

5. The charged particle according to claim 4, wherein when the particle size of the first minute particle is d1 and the particle size of the second minute particle is d2, the minute particles are attached such that there is the relationship:
d2≧d1.

6. The charged particle according to claim 3, wherein the first minute particle is a positively charged resin minute particle, and the second minute particle is an oxide inorganic minute particle.

7. The charged particle according to claim 6, wherein the coverage with the second minute particle is 25 to 50%.

8. The charged particle according to claim 6, wherein the charge potential of the charged particle in a state where the first minute particle has been adhered to the surface of the mother material, and the second minute particle has not been adhered, is 110 mV or more.

9. An electrophoretic display medium comprising the charged particle as set forth in claim 1.

10. An electrophoretic display medium comprising the positively charged particle as set forth in claim 6, and a negatively charged particle in which an oxide inorganic minute particle is attached to a mother material.

11. An image display device comprising the electrophoretic display medium as set forth in claim 9.

12. A charged particle used for an electrophoretic display medium in which a first minute particle being charged with a predetermined polarity and a second minute particle having a smaller surface adhesion force than that of the first minute particle are attached to a mother particle,
wherein when the charged particle comes into contact with another surface, the second minute particle contacts with the surface, and the mother particle and the first minute particle do not come into contact with the surface.
